(19) United States
(12) Patent Application Publication
(10) Pub. No.: US 2007/0177374 A1
(43) Pub. Date: Aug. 2, 2007

(54) Miniature LED flashlight

(76) Inventor: Hong Phuc Nguyen, Anaheim, CA (US)

Correspondence Address: HONG PHUC NGUYEN, 154 S. BIRCHWOOD ST, ANAHEIM, CA, 92808, US

(21) Appl. No.: 11/264,108

(22) Filed: Jan. 27, 2006

(51) Int. Cl. F21L 4/00

(52) U.S. Cl. 362/157

(57) ABSTRACT

A miniature flashlight using a silicone part as switch, a light emitting diode (LED), one or multiple batteries, and a housing to protect the parts mentioned above. The housing is comprised of a top cover and a bottom cover which could be engraved for decoration purpose. See the following descriptions and drawings.

### BACKGROUND OF THE INVENTION

The idea behind this invention is to use the minimum amount of parts and a very simple method of assembly of the parts to obtain a functional and reliable LED flashlight.

The only parts required are one or multiple LED light bulbs, one or multiple coin type batteries as power source, one piece of silicone acting as a switch, a top and bottom cover.

The following descriptions will cover the use of one LED and one battery for simplicity.

### BRIEF DESCRIPTION OF THE DRAWINGS

FIG. 1 is an isometric view of the lighting unit

FIG. 2 is a top view of the lighting unit

FIG. 3 is a side view of the lighting unit

FIG. 4 is a top view of the whole flashlight assembly

FIG. 5 is a front view of the whole flashlight assembly

FIG. 6 is a side view of he whole flashlight assembly

FIG. 7 is a longitudinal cross section of the flashlight assembly along section line A-A depicted in FIG. 4

FIG. 8 is an isometric view of the inside of the top cover

FIG. 9 is an isometric view of the inside of the bottom cover

FIG. 10 is a cross section view of the lighting unit

FIG. 11 is a cross section view of the lighting unit

### PARTS DESCRIPTION

Silicone switch 1
LED light bulb 2
Battery 3
Top cover 4
Bottom cover 5
Hole for key ring 6
Engraved graphic 7

### DETAILED DESCRIPTION OF THE INVENTION

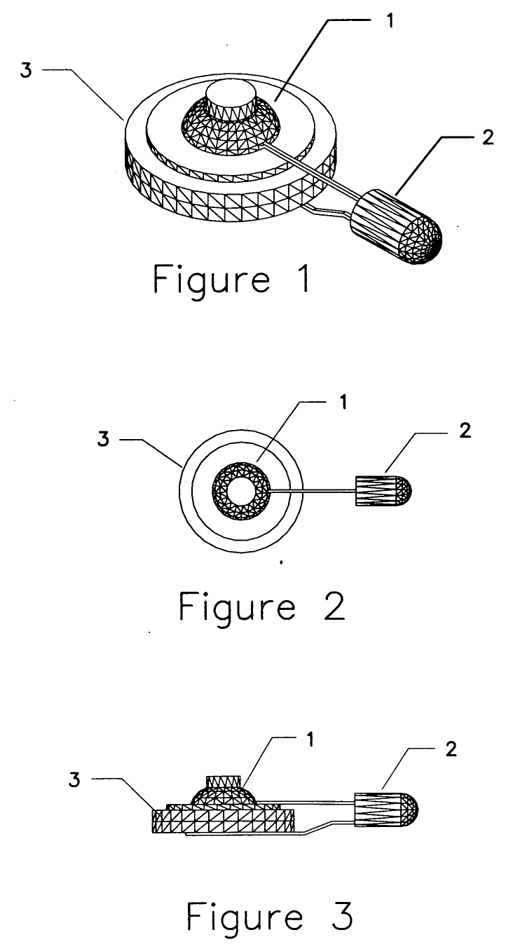

Referring to the drawings FIGS. 1, 2 and 3, the basic lighting unit comprise of a silicone switch 1 having a flat donut shape bottom, a hollow spherical shape wall body and a cylindrical shape top; the LED 2; and the battery 3.

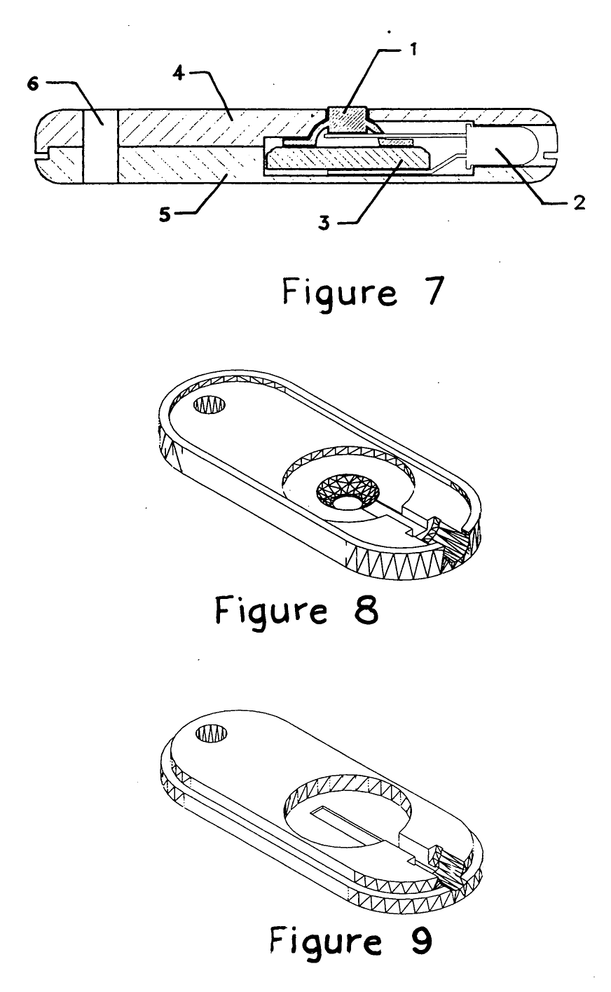

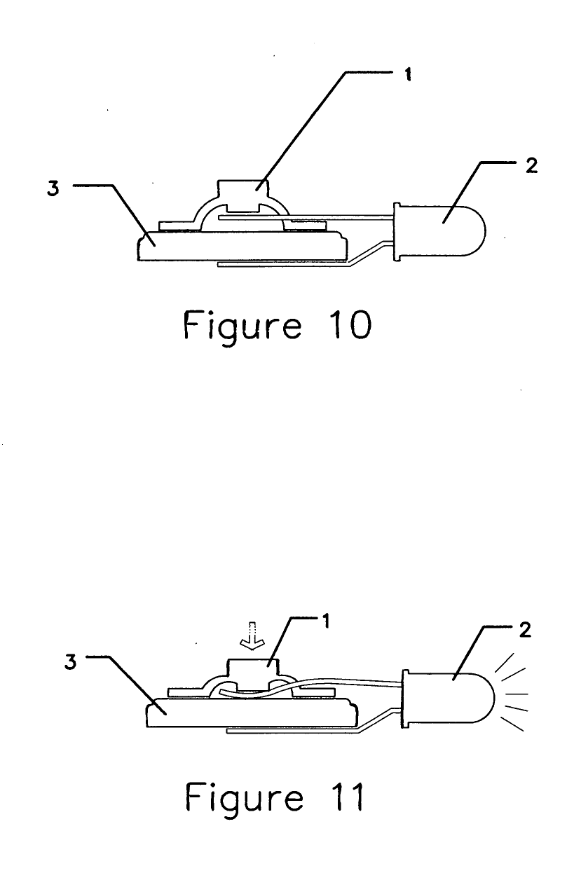

The method of assembly of the lighting unit is depicted in FIGS. 7 & 10 The top positive wire is pushed through a side wall of the silicone switch and placed on top of the positive side of the battery. The bottom negative wire of the LED is bent and is placed in direct contact with the negative side of the battery. The flat donut shape of the silicone switch will prevent the top wire from having direct contact with the battery.

When a force is applied on the top of the silicone switch 1 as depicted in FIG. 11, the body of the switch will deform and will push the top wire of the LED down to have contact with the battery and the LED will light up.

When the force applied is removed, the silicone switch will go back to its original shape due to the elastic property of the material as depicted in FIG. 8. The thickness of the flat bottom of the silicone switch will push the wire up from the battery surface, therefore no more contact.

Note: during assembly, the polarity of the battery and the LED wire can be reversed with the negative LED wire on top and pushed throught the switch and the negative side of the battery faced upward.

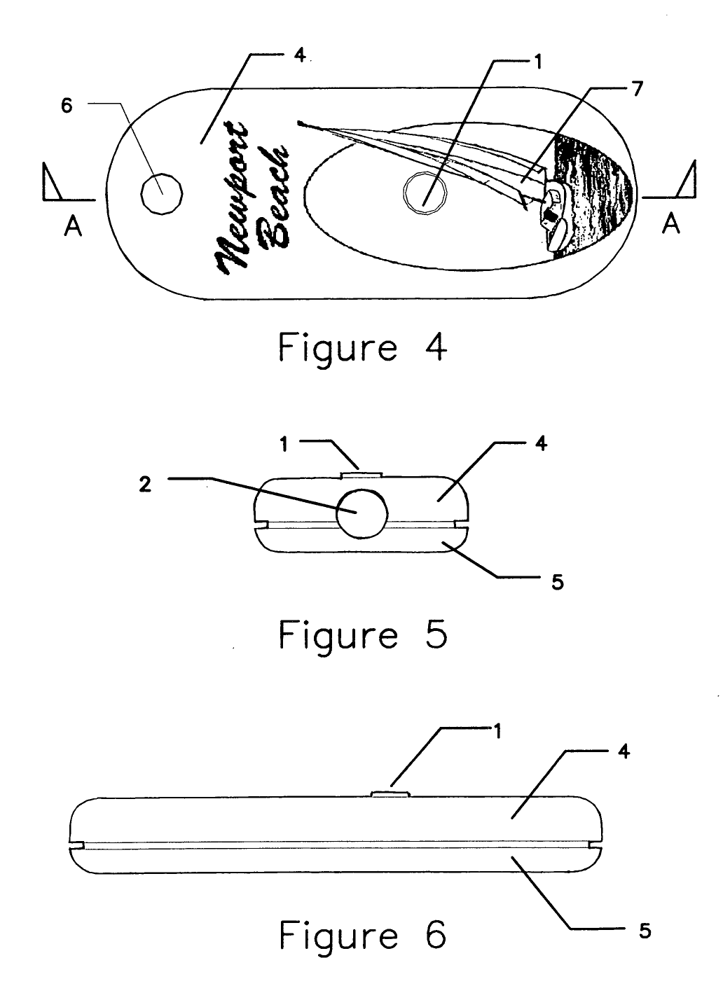

The top cover 4 and bottom cover 5 is hollowed to accommodate the battery the switch and the LED as depicted in FIGS. 7, 8 & 9. A hole 6 as depicted in FIG. 4 is provided to accommodate a key ring. The top cover 4 and the bottom cover 5 can both accommodate engraved decorating or promotional graphics 7.

What is claimed:

1. A light emitting diode (LED) flashlight comprising: A silicone switch, one or multiple LED light bulb, one or multiple coin type batteries, a housing having a top and bottom cover.

2. The LED has two wires. One LED wire has direct contact with one side of the battery. The other wire is pushed through one side wall of the silicone switch. The silicone switch acts as an isolant and prevents the wire from having direct contact with the other side of the battery.

3. A housing having a top cover and bottom cover to protect the assembly. The covers are engraved for decoration purpose and has a hole at one end so it can be attached to a key ring.
